(19) United States
(12) Patent Application Publication
(10) Pub. No.: US 2007/0275755 A1
(43) Pub. Date: Nov. 29, 2007

(54) MOBILE WIRELESS CONSOLE

(75) Inventors: Kyoung Soo CHAE, GYUNGGI-DO (KR); Ghun HAHM, SEOUL (KR); Hyun Joon KIM, GYUNGGI-DO (KR)

Correspondence Address: LOWE HAUPTMAN HAM & BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/696,556

(22) Filed: Apr. 4, 2007

(30) Foreign Application Priority Data
May 24, 2006 (KR) 10-2006-0046773

(51) Int. Cl. H04M 1/00

(52) U.S. Cl. 455/557

(57) ABSTRACT

A mobile wireless console which senses three dimensional motion in a mobile terminal to wirelessly transmit a sensing signal of the three dimensional motion to an electronic device such as a computer. In the console, an inputter allows communication mode and motion mode to be inputted. A controller controls execution of the communication mode inputted through the inputter and execution of the motion mode inputted through the inputter. A motion sensing part senses a three axis straight motion and a three axis rotary motion in response to the execution of the motion mode controlled by the controller. A wireless transmitter wirelessly transmits a sensing signal from the motion sensing part. A displayer displays data in response to control of the controller. Also, a wireless communicator communicates in response to the execution of the communication mode controlled by the controller.

### CLAIM OF PRIORITY

This application claims the benefit of Korean Patent Application No. 2006-46773 filed on May 24, 2006 in the Korean Intellectual Property Office, the disclosure of which is incorporated herein by reference.

### BACKGROUND OF THE INVENTION

1. Field of the Invention

The present invention relates to a mobile wireless console applied to a mobile terminal such as a mobile phone, more particularly, which senses three dimensional motion in the mobile terminal and wirelessly transmits a sensing signal of the three dimensional motion to an electronic device such as a computer, thereby manipulating a three dimensional motion game through the computer interworking with a large TV screen.

2. Description of the Related Art

In general, a mobile terminal such a mobile phone performs a specific function, as exemplified by telephony of the mobile phone and data communication of a personal digital assistant (PDA). The mobile phone will be explained with reference to FIG. 1.

FIG. 1 is a configuration view illustrating a conventional mobile phone.

The mobile phone 10 shown in FIG. 1 includes an inputter 11, a controller 12, a displayer 14 and a communicator 13. The inputter allows a key input. The controller 12 controls an operation in accordance with the key input through the inputter 11. The displayer 14 displays data in response to control of the controller 12. Also, the communicator 13 communicates in response to control of the controller 12.

However, such a conventional mobile phone performs only telephony function but cannot recognize motion, thus failing to carry out motion-related operation, such as a motion game.

In the meantime, the mobile terminal such as the mobile phone may be mounted with a motion recognition sensor and internally equipped with a program interworking with the motion recognition sensor of the mobile terminal. Here, in a case where the motion recognition sensor is employed as an input device for games, the program for games interworking with the sensor is rendered less useful due to too small a display screen of the mobile terminal. This calls for use of a large display.

### SUMMARY OF THE INVENTION

The present invention has been made to solve the foregoing problems of the prior art and therefore an aspect of the present invention is to provide a mobile wireless console which senses three dimensional motion in a mobile terminal to transmit a sensing signal of the three dimensional motion to an electronic device such as a computer, thereby manipulating a three dimensional motion game through a computer interworking with a large TV screen.

According to an aspect of the invention, the invention provides a mobile wireless console. The mobile wireless console includes an inputter for allowing communication mode and motion mode to be inputted; a controller for controlling execution of the communication mode inputted through the inputter and execution of the motion mode inputted through the inputter; a motion sensing part for sensing a three axis straight motion and a three axis rotary motion in response to the execution of the motion mode controlled by the controller; a wireless transmitter for wirelessly transmitting a sensing signal from the motion sensing part; a displayer for displaying data in response to control of the controller; and a wireless communicator for communicating in response to the execution of the communication mode controlled by the controller.

The motion sensing part includes a three axis straight motion sensing part for sensing the three axis straight motion; and a three axis rotary motion sensing part for sensing the three axis rotary motion.

The three axis straight motion sensing part includes an X axis straight sensor for sensing straight motion along an X axis; a Y axis straight sensor for sensing straight motion along a Y axis perpendicular to the X axis; and a Z axis straight sensor for sensing straight motion along a Z axis perpendicular to the X and Y axes, respectively.

The three axis rotary motion sensing part includes an X axis rotary sensor for sensing rotary motion about an X axis; a Y axis rotary sensor for sensing rotary motion about a Y axis perpendicular to the X axis; and a Z axis rotary sensor for sensing rotary motion about a Z axis perpendicular to the X and Y axes, respectively.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a configuration view illustrating a conventional mobile phone;

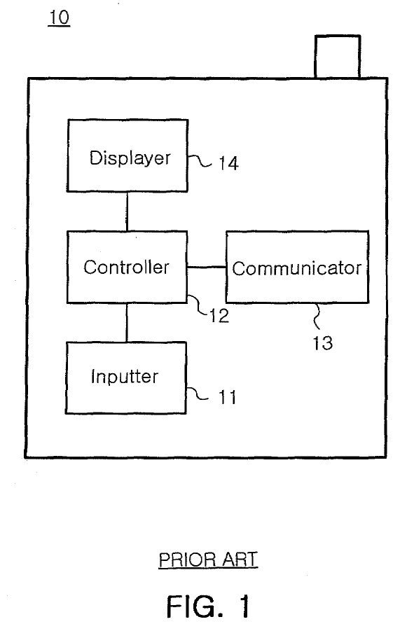

FIG. 2 is a configuration view illustrating a mobile wireless console according to the invention;

FIG. 3 (a) to (b) are configuration views illustrating a motion sensor of FIG. 2;

FIG. 4 is an explanatory view illustrating the operation principle of a three axis rotary motion sensor of FIG. 3; and

FIG. 5 is a configuration view illustrating a game system employing a mobile wireless console according to the invention.

### DETAILED DESCRIPTION OF THE PREFERRED EMBODIMENT

Exemplary embodiments of the present invention will now be described in detail with reference to the accompanying drawings.

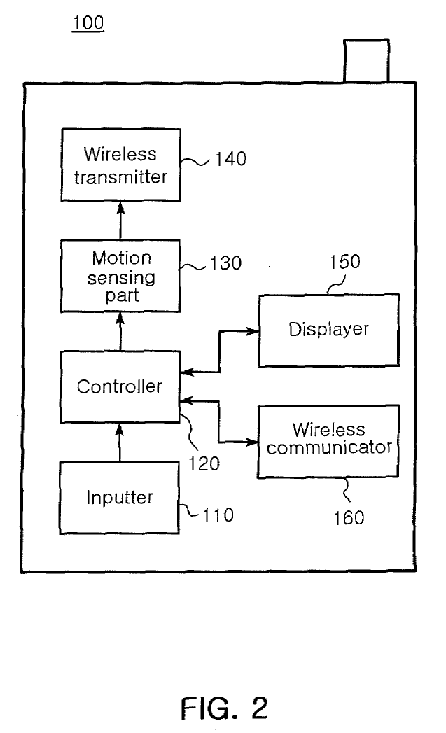

FIG. 2 is a configuration view illustrating a mobile wireless console according to the invention.

Referring to FIG. 2, the wireless console for games of the invention includes an inputter 110, a controller 120, a motion sensing part 130, a wireless transmitter 140, a displayer 150 and a wireless communicator 160. The inputter 110 allows communication mode and motion mode to be inputted. The controller 120 controls execution of the communication mode inputted through the inputter 110 and execution of the motion mode inputted through the inputter 110. The motion sensing part 130 senses a three axis straight motion and a three axis rotary motion in response to the execution of the mobile mode controlled by the controller 120. The wireless transmitter 140 wirelessly transmits a sensing signal from the motion sensing part 130. The displayer 150 displays data in response to control of the controller 120. Also, the wireless communicator 160 communicates in response to the execution of the communication mode controlled by the controller 120.

The controller 120 recognizes mode selection through the inputter 110. Here, in a brief explanation for recognition of mode selection, a mode can be selected by arbitrary combination of two buttons or with a specific button. Alternatively, the mode can be selected from a menu.

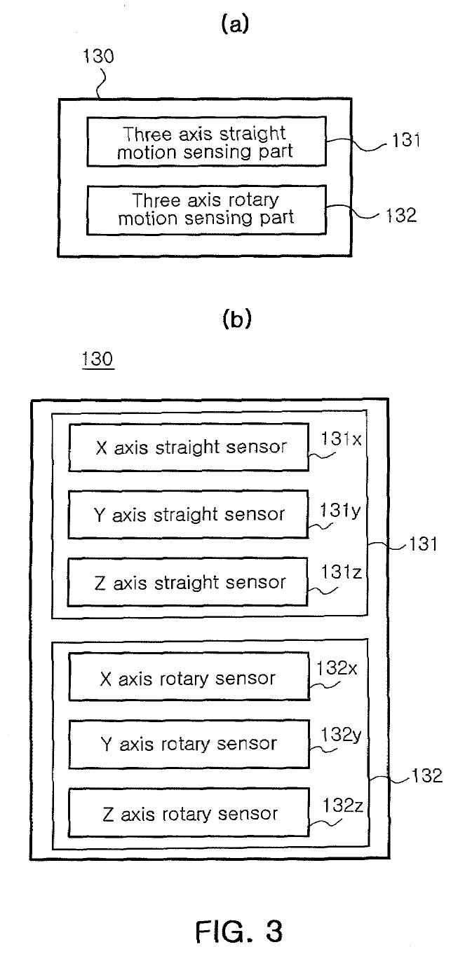

FIG. 3 is a configuration view illustrating the motion sensing part of FIG. 2. The motion sensing part 130 includes a three axis motion sensing part 131 for sensing the three axis straight motion and a three axis rotary motion sensing part 132 for sensing the three axis rotary motion.

The three axis straight motion sensing part 131 includes an X axis straight sensor 131x, a Y axis straight sensor 131y and a Z axis straight sensor 131z. The X axis straight sensor 131x senses straight motion along an X axis. The Y axis straight sensor 131y senses straight motion along a Y axis perpendicular to the X axis. The Z axis straight sensor 131z senses straight motion along a Z axis perpendicular to the X and Y axes, respectively.

Meanwhile, the three axis rotary motion sensing part 132 includes an X axis rotary sensor 132x, a Y axis rotary sensor 132y and a Z axis rotary sensor 132z. The X axis rotary sensor 132x senses rotary motion about an X axis. The Y axis rotary sensor 132y senses rotary motion about a Y axis perpendicular to the X axis. The Z axis rotary sensor 132z senses rotary motion about a Z axis perpendicular to the X and Y axes, respectively.

For example, the three axis straight motion sensing part 131 is configurable as an acceleration sensor for detecting physical quantity of acceleration while the three axis rotary motion sensing part 132 is configurable as an inertia sensor such as a gyro sensor for detecting rotary acceleration.

Here, the acceleration sensor converts physical quantity of acceleration into an electrical signal and breaks down into capacitance, piezoelectric and pyroelectric types depending on a conversion method. The capacitance type sensor converts capacitance change effected according to acceleration into a voltage. The piezoelectric type sensor converts resistance change of a resistor into a voltage. Also, the piezoelectric type sensor converts thermal distribution change into a voltage.

Moreover, the gyro sensor converts a rotary angular velocity into an electrical signal. The gyro sensor converts into a voltage signal capacitance change in accordance with change in the rotary angular velocity applied.

Accordingly, an accelerometer acts as a sensor for sensing straight motion and the gyro sensor functions as a sensor for sensing rotary motion. Thus, a three axis accelerometer and a three axis gyro sensor, if adopted for a game, can recognize straight motion, right and left motion and rotation.

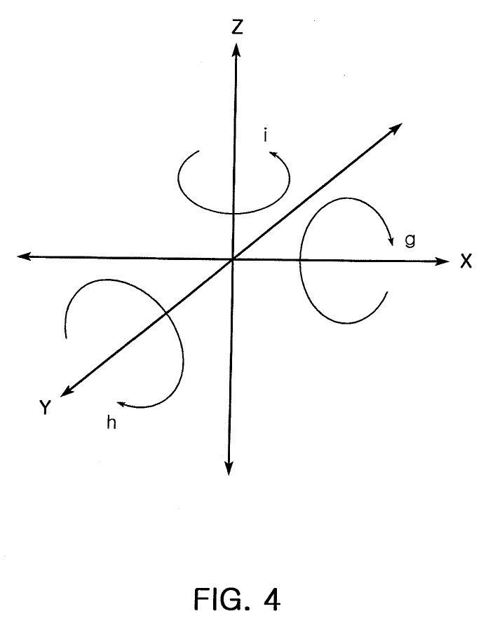

FIG. 4 is an explanatory view for explaining operation of the three axis rotary motion sensor of FIG. 3.

In FIG. 4, an X axis is a horizontal axis, a Z axis is a longitudinal axis perpendicular to the X axis, a Y axis extends from an upper right side to a lower left side perpendicularly to the X and Y axes, respectively. g denotes rotary motion about the X axis, h denotes rotary motion about the Y axis and i denotes rotary motion about the Z axis.

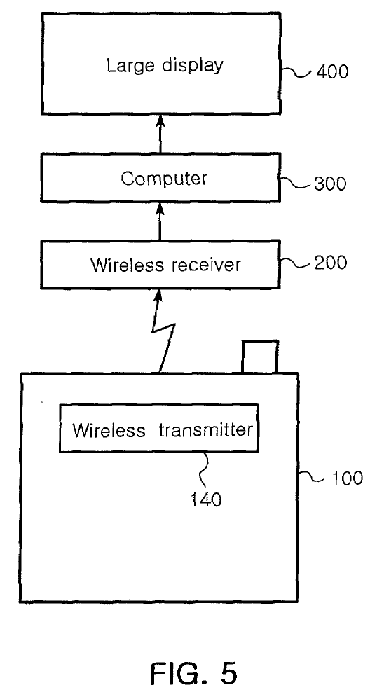

The mobile wireless console of the invention as just described can be adopted in a game or as a secrete key. FIG. 5 explains the mobile wireless console which is used in the game.

FIG. 5 is a configuration view illustrating a game system employing a wireless console according to the invention.

Referring to FIG. 5, the mobile wireless console 100 can be adopted to implement a game system. The game system includes the mobile wireless console 100, a wireless receiver 200, a computer 300 and a large display 400. The mobile wireless console 100 senses motion on three axes to transmit wirelessly. The wireless receiver 200 receives a wireless signal from the mobile wireless console 100. The computer 300 applies the three axis motion to the game in play in response to a signal from the wireless receiver 200. Also, the large display 400 outputs an image of the game playing in the computer 300.

Operation and effects of the invention will be explained in detail hereunder with reference to the accompanying drawings.

In a case where the mobile wireless console is adopted for a mobile phone, a large TV screen can interwork with the computer by the mobile phone, thereby manipulating a three dimensional motion game of the computer via the mobile phone.

An explanation will be given about the mobile wireless console of the invention with reference to FIGS. 2 to 5. First, in the mobile wireless console of FIG. 2, motion mode or communication mode is inputted to a controller 120 through an inputter 110.

For example, in a case where the mobile wireless console of the invention is a mobile phone, communication mode or motion mode can be selected through the inputter 110.

Here, if motion mode is selected through the inputter, the controller 120 controls execution of the motion mode. Meanwhile, if communication mode is selected through the inputter 110, the controller 120 controls execution of the communication mode.

Moreover, a motion sensing part 130 of the invention senses a three axis straight motion and a three axis rotary motion in response to the execution of the motion mode controlled by the controller 120 and transmits a sensing signal from the motion sensing part 130 to a wireless transmitter 140.

The wireless transmitter 140 transmits the sensing signal from the motion sensing part 130 wirelessly. That is, the wireless transmitter 140 converts the sensing signal from the motion sensing part 130 into a high frequency signal to transmit. For example, the wireless transmitter 140 can be configured as a Zigbee telecommunication network or a Blue Tooth telecommunication network, which uses a high frequency signal of 2.4 GHz.

A displayer 150 of the invention displays on a screen data in response to control of the controller 120, for example, a selection mode for identifying the motion mode or the communication mode and a specific operation status in the present selection mode.

Furthermore, when communication mode is selected through the inputter 10, the controller 120 of the invention controls operation of the wireless communicator 160. In turn, the wireless communicator 160 communicates according to the execution of the communication mode controlled by the controller 120.

Here, communication according to the invention may include telephony of the mobile phone and communication of the mobile telecommunication device.

Operation of the motion sensing part 130 will be explained in detail with reference to FIGS. 3 and 4.

Referring to FIG. 3 (a), the motion sensing part 130 includes a three axis straight motion sensing part 131 and a three axis rotary motion sensing part 132.

Referring to FIG. 3 (b), the three axis straight motion sensing part 131 includes an X axis straight sensor 131x, a Y axis straight sensor 131y and a Z axis straight sensor 131z, while the three axis rotary motion sensing part 132 includes an X axis rotary sensor 132x, a Y axis rotary sensor 132y and a Z axis rotary sensor 132z.

The X axis straight sensor 131x in the three axis straight motion sensing part 131 senses straight motion along an X axis. The Y axis straight sensor 131y senses straight motion along a Y axis perpendicular to the X axis. The Z axis straight sensor 131z senses straight motion along a Z axis perpendicular to the X and Y axes, respectively.

In this fashion, the three axis straight motion sensing part 131 senses straight motion on the X, Y and Z axes, respectively to transmit a sensing signal of the straight motion on the three axes to the wireless transmitter 140.

An explanation will be given about how to utilize the three axis straight motion sensing part 131 as just described.

Referring to FIG. 4, as shown in FIG. 4, vibrations/inclinations of the mobile wireless console of the invention are sensed in directions including up and down, left and right and front and back. The directions have a vector set to x, y and z, respectively. Here, x, y and z each are a natural number of at least 1. In a case where the number of vibrations/inclinations sensed for each direction of up and down, left and right and front and back is designated with a, b and c, the x, y and z directions and size thereof satisfy following Equation 1.

X=ax,˜Y=by,˜Z=cz Equation 1

In the Equation 1, X, Y and Z designate motion amount and direction of an object and thus can be adopted for the mobile wireless console mounted with the motion sensor for sensing X, Y and Z directions and size thereof. For example, when applied to an automobile game, the X, Y and Z directions can be utilized to make an order for shift to the left and the right, progress and stop. Also, when applied to a boxing game, the X, Y and Z directions can be used to order a specific action.

In other applications, the mobile wireless console adopting the X, Y and Z directions can serve as a secret key for turning on/off an electronic device such as TV or executing a game. The application method thereof will be explained hereunder.

First, after a preliminary manipulation for selecting a secret key such as a button input is performed, a motion in a specific direction is stored. In consequence, only with the same motion inputted later on, a TV can be turned on/off or a game can be executed.

When it comes to the above applications, the acceleration sensor employed alone is suitable for recognizing vibration or inclination in a straight direction, but inadequate for rotary motion. This shortcoming can be overcome by adopting the three axis rotary motion sensing part 132.

Furthermore, the X axis rotary sensor 132x of the three axis rotary motion sensing part 132 senses rotary motion about an X axis. Meanwhile, the Y axis rotary sensor 132y senses rotary motion about a Y axis perpendicular to the X axis. The Z axis rotary sensor 132z senses rotary motion about a Z axis perpendicular to the X and Y axes, respectively.

In this fashion, the three axis rotary motion sensing part 132 senses rotary motion for the X, Y and Z axes, respectively to transmit the sensing signal of the three axis rotary motions to the wireless transmitter 140.

As described above, the three axis rotary motion sensing part 132 adopts a gyro sensor for recognizing a rotary angular velocity in order to recognize rotary motion.

Straight motion and rotary motion can be combined according to Equation 2 below. In a case where each rotary direction is defined by g, h and i and rotation amount sensed in each direction is designated with d, e and f, the X, Y and Z directions and size thereof satisfy following Equation 2.

X=ax,˜Y=by,˜Z=cz,˜G=dg,˜H=eh,˜i=fi Equation 2

The combination of straight and rotary motions as represented by the Equation 2 can be utilized in setting a direction of motion during a game in the same manner as in a case where only the accelerometer is employed.

The wireless transmitter 140 wirelessly transmits the sensing signal from the motion sensing part 130 to a wireless transmitter 200 connected to an electronic device such as a computer 300. Also, the displayer 150 of the mobile wireless console 100 displays on a screen data in response to control of the controller 120.

In addition, the wireless communicator 160 of the mobile wireless console 100 communicates according to execution of communication mode by controlled by the controller 120.

Next, an explanation will be given about operation of the wireless receiver 200, the computer 300 and the large display 400.

For example, as shown in FIG. 5, the wireless receiver 200 is connected to the computer 300 and the large display 400 so that a game image from the computer 300 can be played by the large display 400.

That is, the wireless receiver 200 receives a wireless signal from the wireless transmitter 140 of the mobile wireless console 100 to transmit to the computer 300. In turn, the computer 300 applies motion data included in the transmitted signal to a game in play to output the image of the game through the large display 400.

As described above, the mobile wireless console of the invention can be easily connected to a large display such as TV at any place and at any time, thereby ensuring a game using the large display to be enjoyed more easily and in diverse places.

As set forth above, according to exemplary embodiments of the invention, in a mobile wireless console employed in a mobile terminal, a three dimensional (3D) motion is sensed and a 3D sensing signal is wirelessly transmitted to an electronic device such as a computer. This enables manipulation of a 3D motion game through the computer interworking with a large TV screen.

While the present invention has been shown and described in connection with the preferred embodiments, it will be apparent to those skilled in the art that modifications and variations can be made without departing from the spirit and scope of the invention as defined by the appended claims.

What is claimed is:

1. A mobile wireless console comprising:
an inputter for allowing communication mode and motion mode to be inputted;
a controller for controlling execution of the communication mode inputted through the inputter and execution of the motion mode inputted through the inputter;
a motion sensing part for sensing a three axis straight motion and a three axis rotary motion in response to the execution of the motion mode controlled by the controller;
a wireless transmitter for wirelessly transmitting a sensing signal from the motion sensing part;
a displayer for displaying data in response to control of the controller; and
a wireless communicator for communicating in response to the execution of the communication mode controlled by the controller.

2. The mobile wireless console according to claim 1, wherein the motion sensing part comprises:
a three axis straight motion sensing part for sensing the three axis straight motion; and
a three axis rotary motion sensing part for sensing the three axis rotary motion.

3. The mobile wireless console according to claim 2, wherein the three axis straight motion sensing part comprises:
an X axis straight sensor for sensing straight motion along an X axis;
a Y axis straight sensor for sensing straight motion along a Y axis perpendicular to the X axis; and
a Z axis straight sensor for sensing straight motion along a Z axis perpendicular to the X and Y axes, respectively.

4. The mobile wireless console according to claim 2, wherein the three axis rotary motion sensing part comprises:
an X axis rotary sensor for sensing rotary motion about an X axis;
a Y axis rotary sensor for sensing rotary motion about a Y axis perpendicular to the X axis; and
a Z axis rotary sensor for sensing rotary motion about a Z axis perpendicular to the X and Y axes, respectively.
